(19) United States
(12) Patent Application Publication
(10) Pub. No.: US 2026/0361991 A1
(43) Pub. Date: Nov. 12, 2026

(54) ELECTRONIC DEVICE AND CONTINUOUS SHOOTING METHOD THEREOF

(71) Applicant: ASUSTeK COMPUTER INC., Taipei City (TW)

(72) Inventors: Hsin-Ju Tsai, Taipei City (TW); Chang-Tai Lee, Taipei City (TW)

(73) Assignee: ASUSTeK COMPUTER INC., Taipei City (TW)

(21) Appl. No.: 19/655,711

(22) Filed: Apr. 23, 2026

(30) Foreign Application Priority Data
May 7, 2025 (TW) 114117082

(51) Int. Cl. H04N 23/61; H04N 23/63; H04N 23/667

(52) U.S. Cl. CPC H04N 23/61; H04N 23/632; H04N 23/667

(57) ABSTRACT

Provided are an electronic device and a continuous shooting method thereof. The method is adapted to the electronic device with an image sensor and comprises the following steps. A preview image is acquired using the image sensor. Based on an object recognition result of the preview image, whether to enable a continuous shooting mode is determined. Upon enabling the continuous shooting mode, a source image stream for the continuous shooting mode is configured according to a remaining storage space. The source image stream is generated from a plurality of raw images captured by the image sensor. Upon receiving a shooting request, a plurality of consecutive images are acquired by using the source image stream. The consecutive images corresponding to the shooting request are stored.

### CROSS-REFERENCE TO RELATED APPLICATION

This application claims the priority benefit of Taiwan application serial no. 114117082, filed on May 7, 2025. The entirety of the above-mentioned patent application is hereby incorporated by reference herein and made a part of this specification.

### BACKGROUND

### Technical Field

The disclosure relates to a continuous shooting method and an electronic device using the method.

### Related Art

With the advancement of technology, electronic devices with image capturing function have become ubiquitous in modern life. When photographing people or animals, slight movements of the photography subject or shutter delay during the shooting process usually leads to unsatisfactory final images. To solve this problem, most existing electronic devices are equipped with continuous shooting function. When the user presses the shutter, the camera application automatically shoots multiple photos continuously, allowing the user to select the best image in the album for sharing or storage.

However, there are some significant disadvantages in the use of current continuous shooting mode. First, multiple photos generated by continuous shooting occupy several times the storage space of a single photo, which is a significant burden for users with limited device storage resources. Second, many users mostly choose to set this function to off by default, and only manually enable the function when they need to photograph people or animals. However, when photographing moving people or animals, the situation usually requires immediate response, and users usually cannot manually enable the continuous shooting function in time. In such cases, the photos taken often fail to achieve the expected effect, leading the user regret during later review.

### SUMMARY

The disclosure provides a continuous shooting method, for an electronic device with an image sensor, and the method comprises the following steps. A preview image is acquired using the image sensor. Based on an object recognition result of the preview image, whether to enable a continuous shooting mode is determined. Upon enabling the continuous shooting mode, a source image stream for the continuous shooting mode is configured according to a remaining storage space. The source image stream is generated from a plurality of raw images captured by the image sensor. Upon receiving a shooting request, a plurality of consecutive images are acquired by using the source image stream. The consecutive images corresponding to the shooting request are stored.

The disclosure also provides an electronic device, which comprises an image sensor and a processor. The processor is coupled to the image sensor. The processor is configured to perform the following operations. A preview image is acquired using the image sensor. Based on an object recognition result of the preview image, whether to enable a continuous shooting mode is determined. Upon enabling the continuous shooting mode, a source image stream for the continuous shooting mode is configured according to a remaining storage space. The source image stream is generated from a plurality of raw images captured by the image sensor. Upon receiving a shooting request, a plurality of consecutive images are acquired by using the source image stream. The consecutive images corresponding to the shooting request are stored.

Based on the above, in the embodiment of the disclosure, the continuous shooting mode may be automatically activated based on the object recognition result of the preview image. In addition, the source image stream for the continuous shooting mode is configured according to the remaining storage space. Based on the above, missing the best shooting opportunity due to the use of continuous shooting function may be avoided, and the file size of consecutive images may be reduced when the storage space is insufficient, thereby enhancing the practicality and timeliness of the continuous shooting function.

### BRIEF DESCRIPTION OF THE DRAWINGS

FIG. 1 is a block diagram of an electronic device according to an embodiment of the disclosure.

FIG. 2 is a flowchart of a continuous shooting method according to an embodiment of the disclosure.

FIG. 3 is a flowchart of whether to enable the continuous shooting mode according to an embodiment of the disclosure.

FIG. 4 is a flowchart of determining a source image stream according to an embodiment of the disclosure.

FIG. 5 is a flowchart of a camera application issuing a continuous shooting command according to an embodiment of the disclosure.

FIG. 6 is a flowchart of generating consecutive images according to a shooting request according to an embodiment of the disclosure.

FIG. 7 is a schematic diagram of acquiring the consecutive images from a preview image stream according to an embodiment of the disclosure.

FIG. 8 is a schematic diagram of acquiring the consecutive images from a formal shooting image stream according to an embodiment of the disclosure.

FIG. 9 is a schematic diagram of deleting duplicate images according to an embodiment of the disclosure.

FIG. 10 is a schematic diagram of an operation interface according to an embodiment of the disclosure.

### DESCRIPTION OF THE EMBODIMENTS

Reference will now be made in detail to exemplary embodiments of the disclosure, and examples of the embodiments are illustrated in the accompanying drawings. Wherever possible, the same reference numerals are used in the drawings and descriptions to refer to the same or similar parts. The embodiments are merely a part of the disclosure and do not disclose all possible implementations of the disclosure. More precisely, the embodiments are merely examples of the devices and methods in the appended claims of the disclosure.

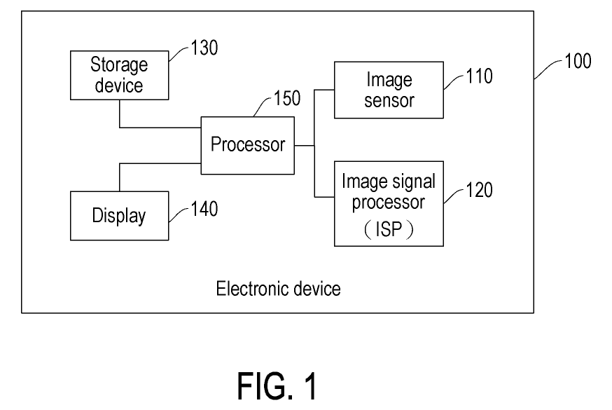

Referring to FIG. 1, in one embodiment, an electronic device 100 comprises an image sensor 110, an image signal processor (ISP) 120, a storage device 130, a display 140, and a processor 150. In one embodiment, the electronic device 100 is a smartphone, a tablet computer, a game console, an electronic wearable device, or a photographic device, or various electronic devices with image shooting function, and the type of the electronic device 100 is not limited thereto.

In one embodiment, the image sensor 110 is configured to shoot images, which comprises lenses, image sensing components, and other components. In one embodiment, the lens comprises optical lenses, which are used for optical path control. The image sensing component is configured to provide image sensing function. In one embodiment, the image sensing component comprises photosensitive components, such as charge coupled device (CCD), complementary metal-oxide semiconductor (CMOS) components or other components, and the disclosure is not limited thereto. The lens may converge imaging light on the image sensing component to achieve the purpose of capturing images.

The image signal processor (ISP) 120 is configured to process image data in real time. In one embodiment, The image signal processor 120 performs front-end image processing on the raw image captured by the image sensor 110. For example, the image signal processor 120 performs image optimization processing such as contrast enhancement, color correction, sharpening, and noise reduction on the raw image.

In one embodiment, the storage device 130 is configured to store files, images, commands, program codes, software modules, and other data, which may be, for example, any type of fixed or removable random access memory (RAM), read-only memory (ROM), flash memory, hard disk, or other similar devices, integrated circuits, or combinations thereof.

In one embodiment, the display 140 is a liquid crystal display (LCD), light emitting diode (LED) display, organic light emitting diode (OLED) or various types of displays, and the disclosure is not limited thereto. In one embodiment, the display 140 is configured to display program operation interfaces of a camera application and a camera preview image.

In one embodiment, the processor 150 is coupled to the display 140, the image sensor 110, the image signal processor 120, and the storage device 130. In one embodiment, the processor 150 is a central processing unit (CPU), an application processor (AP), or other programmable general-purpose or special-purpose microprocessor, a digital signal processor (DSP), an image signal processor (ISP), a graphics processing unit (GPU), or other similar devices, integrated circuits, or combinations thereof. In some embodiments, the processor 150 executes commands or program codes in the storage device 130 to implement various steps of the continuous shooting method in the embodiments of the disclosure.

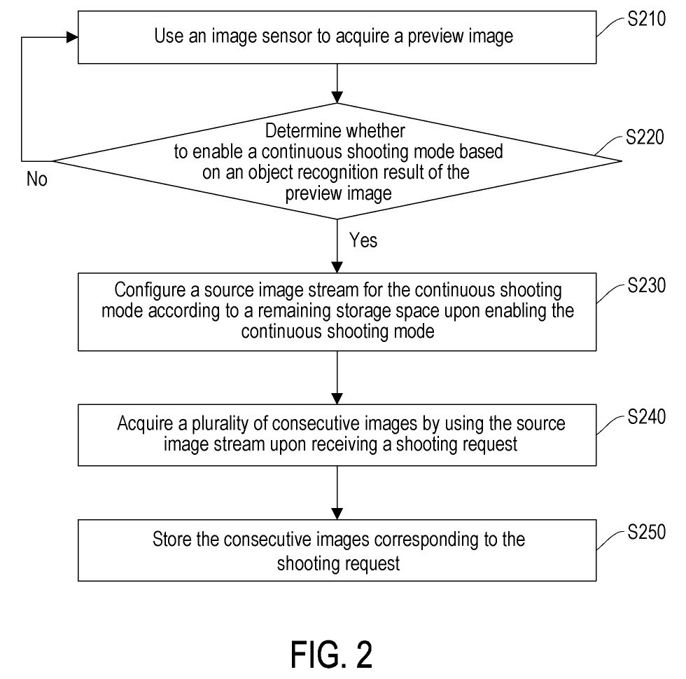

FIG. 2 is a flowchart of a continuous shooting method according to an embodiment of the disclosure. Referring to FIG. 2, the method of the present embodiment may be executed by the electronic device 100 in FIG. 1, and the details of each step in FIG. 2 will be explained in conjunction with the components shown in FIG. 1.

In Step S210, the processor 150 uses the image sensor to acquire a preview image. Specifically, during the period of a preview mode, the image sensor 110 continuously outputs multiple raw images. The preview image is generated from the raw images and displayed, so that the user views the preview image to determine a shooting timing and a photo composition.

In Step S220, the processor 150 determines whether to enable a continuous shooting mode based on an object recognition result of the preview image. Specifically, the processor 150 determines to enable or disable the continuous shooting mode according to the image content of the preview image. For example, when the preview image comprises a person or animal, the processor 150 enables the continuous shooting mode.

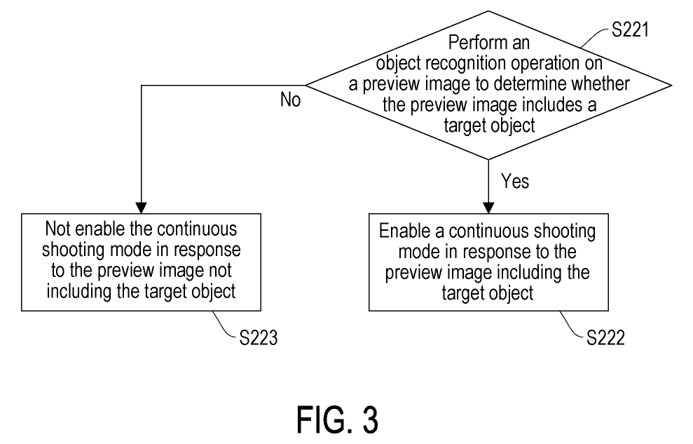

Referring to FIG. 3, which is a flowchart for determining whether to enable the continuous shooting mode according to an embodiment of the disclosure. In some embodiments, Step S220 is implemented as Step S221 to Step S223.

In Step S221, the processor 150 performs an object recognition operation on the preview image to determine whether the preview image comprises a target object. In some embodiments, the processor 150 utilizes a trained convolutional neural network model to perform object recognition on the preview image. The trained convolutional neural network model is configured to recognize the target object in the input image. The convolutional neural network model is, for example, an object detection model for object recognition, such as R-CNN, Fast RCNN, Faster R-CNN, YOLO, or SSD, and the disclosure is not limited thereto. The target object is, for example, a person or animal. Alternatively, in some embodiments, the processor 150 determines whether the preview image comprises the target object through image processing techniques such as contour detection and skin color detection.

In Step S222, when the preview image comprises the target object (Step S221 determines yes), the processor 150 enables the continuous shooting mode. For example, when the preview image comprises the target object, then it is indicated that the user wants to shoot dynamic persons or animals. Therefore, when determining that the preview image comprises the target object, the processor 150 automatically enables the continuous shooting mode to capture scenes with faster changes through the continuous shooting mode.

In Step S223, when the preview image does not comprise the target object (Step S221 determines no), the processor 150 does not enable the continuous shooting mode. For example, when the preview image does not comprise the target object, then it is indicated that the user wants to shoot a static scene. Therefore, when determining that the preview image does not comprise the target object, the processor 150 does not enable the continuous shooting mode.

From the above, it is known that in some embodiments, the processor 150 actively analyzes whether the shooting subject of the preview image is a dynamic person or animal, to automatically and timely activate the continuous shooting mode, thereby providing a more intelligent shooting experience.

Back to FIG. 2, in Step S230, when the continuous shooting mode is enabled, the processor 150 configures a source image stream for the continuous shooting mode according to a remaining storage space. The source image stream for the shooting mode is generated from the multiple raw images captured by the image sensor 110.

In some embodiments, the source image stream serves as the image source for the continuous shooting mode. The source image stream refers to a real-time data stream generated after being processed by the image signal processor 120. Specifically, the image signal processor 120 performs noise reduction, white balance, color correction, and other processing on the raw images captured by the image sensor 110, and generates one or more image streams suitable for display or storage according to application requirements, such as a preview image stream or a formal shooting image stream.

For example, ISP 120 generates a preview image stream according to low resolution and YUV format, and generate a formal shooting image stream according to high resolution and JPEG format. The preview image stream is generally used for real-time display on the screen, helping users with photo composition and shooting parameter adjustment. The resolution of the preview image stream is generated by compressing the raw image through the ISP 120 or a hardware abstraction layer (HAL). In some embodiments, the preview image stream is stored in a circular buffer. The formal shooting image stream is stored in a non-volatile storage device.

In some embodiments, the processor 150 selects the source image stream for the continuous shooting mode from multiple image streams according to the remaining storage space. Alternatively, in some embodiments, the processor 150 creates the source image stream for the continuous shooting mode according to the remaining storage space.

In some embodiments, the remaining storage space is the remaining storage space of the non-volatile storage device, that is, the remaining storage space that is configured to store photographed photos. The non-volatile storage device is a permanent storage device built into the electronic device 100, such as flash memory.

In some embodiments, the processor 150 determines the source image stream for the continuous shooting mode to be a low-resolution preview image stream or a high-resolution formal shooting image stream according to the remaining storage space. The resolution of the preview image stream is smaller than the resolution of the formal shooting image stream.

In some embodiments, when the remaining storage space is below a threshold value, the processor 150 determines the source image stream for the continuous shooting mode to be a preview image stream. The threshold value is configured according to actual requirements, and the disclosure is not limited thereto. That is, when the remaining storage space for storing photographed photos is insufficient, the processor 150 determines that the source image stream for the continuous shooting mode is a preview image stream with lower resolution, thereby avoiding rapid depletion of available storage space.

In some embodiments, when the remaining storage space is not below the threshold value, the processor 150 determines the source image stream for the continuous shooting mode to be a preview image stream or a formal shooting image stream according to ambient light information. The ambient light information is, for example, exposure time or other exposure parameters.

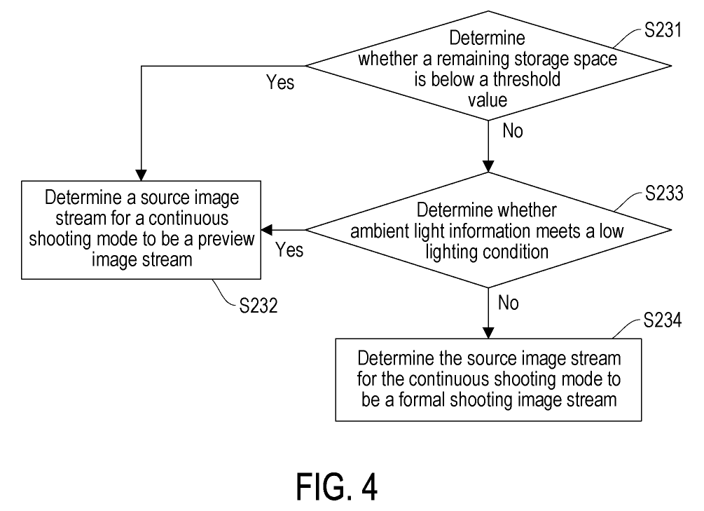

Please refer to FIG. 4, which is a flowchart of determining the source image stream according to an embodiment of this disclosure. In some embodiments, Step S230 is implemented as Step S231 to Step S234.

In Step S231, the processor 150 determine whether the remaining storage space is below a threshold value. When the remaining storage space is below the threshold value (Step S231 determines yes), in Step S232, the processor 150 determines the source image stream for the continuous shooting mode to be the preview image stream. When the remaining storage space is not below the threshold value (Step S231 determines no), in Step S233, the processor 150 determines whether the ambient light information meets a low lighting condition.

In some embodiments, the processor 150 determines whether the exposure time decided by the auto exposure (AE) process is greater than a time threshold value. The time threshold value is, for example, one-thirtieth of a second, but the disclosure is not limited thereto. When the exposure time is greater than the time threshold value, it means that the ambient light of the shooting scene is darker, and the processor 150 determines that the ambient light information meets the low lighting condition. When the exposure time is not greater than the time threshold value, it means that the ambient light of the shooting scene is bright, and the processor 150 determines that the ambient light information does not meet the low lighting condition.

Next, when the remaining storage space is not below the threshold value and the ambient light information meets the low lighting condition (Step S233 determines yes), in Step S232, the processor 150 determines the source image stream for the continuous shooting mode to be the preview image stream. When the remaining storage space is not below the threshold value and the ambient light information does not meet the low lighting condition (Step S233 determines no), in Step S234, the processor 150 determines the source image stream for the continuous shooting mode to be the formal shooting image stream.

In Step S240, upon receiving a shooting request, the processor 150 acquires the multiple consecutive images by using the source image stream. That is to say, in some embodiments, when the remaining storage space is below the threshold value or the ambient light information meets the low lighting condition, the processor 150 utilizes the preview image stream to acquire multiple consecutive images corresponding to the shooting request. When the remaining storage space is not below the threshold value and the ambient light information does not meet the low lighting condition, the processor 150 utilizes the formal shooting image stream to acquire multiple consecutive images corresponding to the shooting request.

Specifically, when the shooting scene is a bright scene, the processor 150 provides high-quality continuous shooting results. When the shooting scene is a low brightness scene, since the formal shooting image stream results in a low frame rate due to excessive exposure time, the processor 150 insteads utilize the preview image stream to acquire consecutive images that are smooth and do not have an excessive overall shooting time.

In some embodiments, the processor 150 increases the ISO value of the preview image stream to shorten the exposure time of the preview image stream and compensate for image brightness.

Returning to FIG. 2, in Step S250, the processor 150 stores the multiple consecutive images corresponding to the shooting request. The processor 150 stores the multiple consecutive images corresponding to the shooting request to a non-volatile storage device (that is, permanent storage device), such as a built-in NAND Flash storage device or an external memory card. The storing format of the images is JPEG format, and also comprises other formats, such as HEIF (High Efficiency Image Format).

In some embodiments, the multiple consecutive images comprises multiple previous consecutive images captured before a request time point of the shooting request, and multiple subsequent consecutive images captured after the request time point of the shooting request.

In some embodiments, upon enabling the continuous shooting mode, a camera application configures the source image stream for the continuous shooting mode according to the remaining storage space. The camera application issues the enabling command for the continuous shooting mode to the camera hardware abstraction layer (camera HAL), and the enabling command is configured to enable the continuous shooting mode and instruct whether the source image stream for the continuous shooting mode is the formal shooting image stream or the preview image stream. The camera hardware abstraction layer provides a standardized interface, allowing the upper-layer camera application to communicate with different hardware devices (that is, the image sensor 110 and the ISP 120) without having to consider the details of the specific hardware. In some embodiments, the camera hardware abstraction layer of the camera system performs some front-end image processing, on the image data from the ISP 120 or image sensor 110, thereby generating multiple image streams.

In some embodiments, the camera application configures shooting parameters and image resolution of the source image stream according to the remaining storage space. In some embodiments, the camera application determines whether to use the preview image stream or the formal shooting image stream as the source image stream according to the remaining storage space configuration, and drive the camera hardware abstraction layer to transmit the consecutive images from the preview image stream or the formal shooting image stream to the camera application.

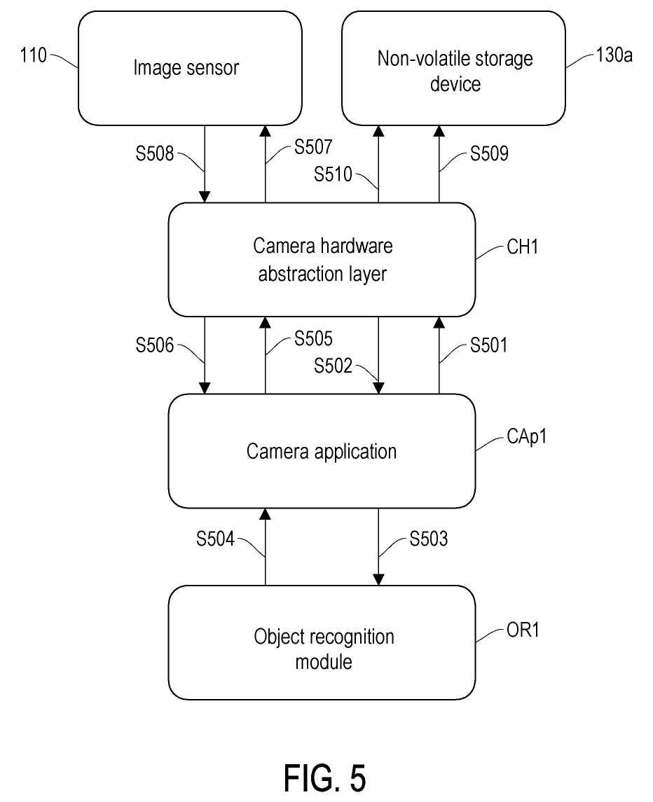

Please refer to FIG. 5, which is a flowchart of a camera application issuing a continuous shooting command according to an embodiment of the disclosure. In Step S501, a camera application CAp1 issues commands to a camera hardware abstraction layer CH1 to open the camera and transmit the preview. In Step S502, the camera hardware abstraction layer CH1 transmits preview images to the camera application CAp1. In Step S503, the camera application CAp1 provides the preview images to an object recognition module OR1 for object recognition operation. In Step S504, the object recognition module OR1 returns the object recognition result to the camera application CAp1.

In Step S505, the camera application CAp1 sends an enabling command or disabling command for the continuous shooting mode to the camera hardware abstraction layer CH1 based on the object recognition result. When the preview image comprises a target object, the camera application CAp1 sends an enabling command for the continuous shooting mode (that is, continuous shooting command) to the camera hardware abstraction layer CH1 to enable the continuous shooting mode. In addition, the camera application CAp1 determines the source image stream for the continuous shooting mode according to the remaining storage space and ambient light information, and notify the camera hardware abstraction layer CH1 of the selection of the source image stream through the enabling command for the continuous shooting mode (that is, the continuous shooting command). In Step S506, the camera hardware abstraction layer CH1 may, in response to the enabling command or disabling command for the continuous shooting mode, return a mode change failure notification or mode change success notification to the camera application CAp1.

On the other hand, in Step S507, when receiving the enabling command for the continuous shooting mode, the camera hardware abstraction layer CH1 notifies the image sensor 110 and the ISP 120 to output images according to the image stream settings of the source image stream.

In Step S508, the camera hardware abstraction layer CH1 receives multiple consecutive shooting images from the formal shooting image stream. It should be noted that in the example of FIG. 5, the explanation is based on the source image stream for the continuous shooting mode being the formal shooting image stream. Therefore, in Step S509, the camera hardware abstraction layer CH1 stores the multiple consecutive shooting images from the formal shooting image stream in JPEG format to the non-volatile storage device 130a, so that consecutive images is generated using the formal shooting image stream when a shooting request is received subsequently. In Step S510, the camera hardware abstraction layer CH1 periodically deletes expired image files temporarily stored in the non-volatile storage device 130a. That is, the camera hardware abstraction layer CH1 deletes useless expired image files in the non-volatile storage device 130a at regular intervals.

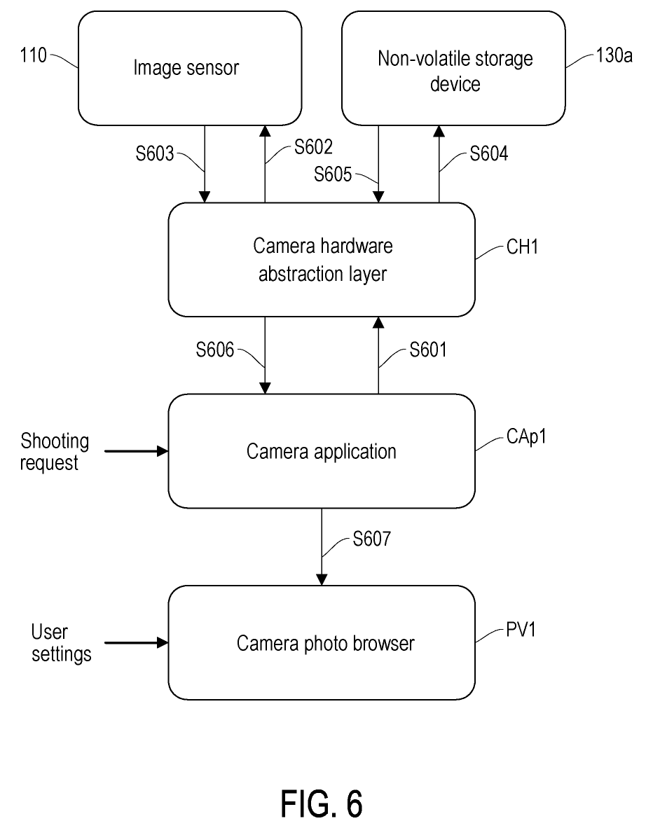

Please refer to FIG. 6, which is a flowchart of generating consecutive images according to a shooting request according to an embodiment of the disclosure. In Step S601, the camera application CAp1 receives a shooting request and issues the shooting request to the camera hardware abstraction layer CH1. In addition, the camera application CAp1 simultaneously issues an enabling command or disabling command for the continuous shooting mode to the camera hardware abstraction layer CH1.

In Step S602, in response to receiving the shooting request and the enabling command for the continuous shooting mode, the camera hardware abstraction layer CH1 controls the image sensor 110 to perform formal shooting to acquire the main image and subsequent consecutive images among the consecutive images. In Step S603, the camera hardware abstraction layer CH1 acquires the main image and subsequent consecutive images among the consecutive images from the image sensor 110. In Step S604, the camera hardware abstraction layer CH1 reads the previous consecutive images among the consecutive images from the non-volatile storage device 130a.

In Step S605, the non-volatile storage device 130a provides the previous consecutive images among the consecutive images to the camera hardware abstraction layer CH1. In Step S606, the camera hardware abstraction layer CH1 returns the previous consecutive images, the main image, and the subsequent consecutive images among the consecutive images to the camera application CAp1. In Step S607, the camera application CAp1 performs image post-processing and archiving operations on these consecutive images. In some embodiments, the camera application CAp1 checks whether there are duplicate image files with the same time stamp that need to be deleted. The user views consecutive images corresponding to a certain shooting request through a camera photo browser.

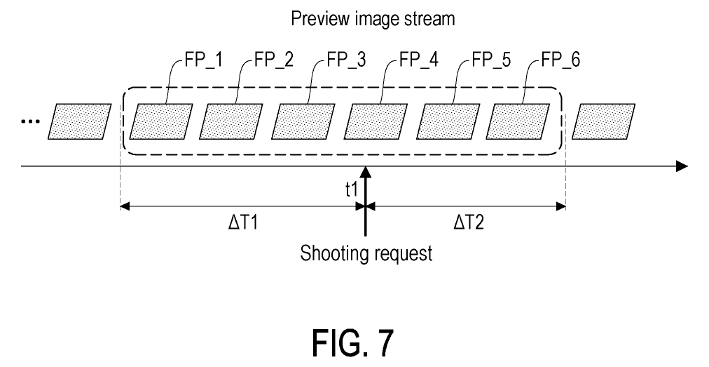

Please refer to FIG. 7, which is a schematic diagram of acquiring the consecutive images from the preview image stream according to an embodiment of the disclosure. In some embodiments, upon receiving the shooting request and the source image stream being the preview image stream, the camera hardware abstraction layer acquires multiple consecutive images FP_1 to FP_6 from the preview image stream according to the request time point of the shooting request. The multiple consecutive images FP_1 to FP_6 comprises a main image corresponding to a request time point t1, multiple previous consecutive images before the main image, and multiple subsequent consecutive images after the main image. As shown in FIG. 7, the consecutive image FP_4 is a main image corresponding to the request time point t1. The consecutive images FP_1 to FP_3 are previous consecutive images. The consecutive images FP_5 to FP_6 are subsequent consecutive images.

In some embodiments, the previous consecutive images is images captured within a first preset time period ΔT1 before the request time point t1. The subsequent consecutive images is images captured within a second preset time period ΔT2 after the request time point t1.

However, in some other embodiments, the previous consecutive images is N images before the main image. The subsequent consecutive images is M images after the main image. The above-mentioned M and N may, for example, be integers in a range of 10 to 20.

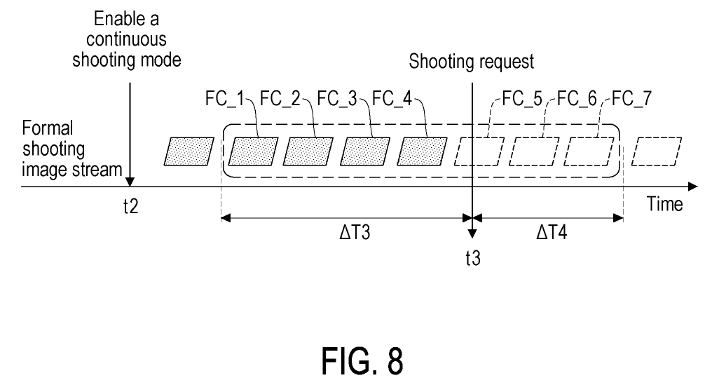

Please refer to FIG. 8, which is a schematic diagram of acquiring the consecutive images from the formal shooting image stream according to an embodiment of the disclosure. In some embodiments, upon receiving the shooting request and the source image stream being the formal shooting image stream, multiple previous consecutive images FC_1 to FC_4 are acquired from the formal shooting image stream among the multiple consecutive images. The previous consecutive images FC_1 to FC_4 are captured before a request time point t3 of the shooting request. Specifically, the camera hardware abstraction layer receives an enabling command for the continuous shooting mode at a time point t2. Then, the camera hardware abstraction layer executes a formal shooting procedure to generate a formal shooting image stream. The image files of the formal shooting image stream is temporarily stored in the non-volatile storage device. Upon receiving a shooting request at the request time point t3, the camera hardware abstraction layer reads out the previous consecutive images FC_1 to FC_4 before the main image from the non-volatile storage device. The camera hardware abstraction layer uses the main image FC_5, the subsequent consecutive images FC_6 to FC_7, and the previous consecutive images FC_1 to FC_4 shot at the request time point t3 and after the request time point t3 as multiple consecutive images for that continuous shooting operation.

In some embodiments, the previous consecutive images is images captured within a first preset time period ΔT3 before the request time point t3. The subsequent consecutive images is images captured within a second preset time period ΔT4 after the request time point t3.

In some embodiments, the processor 150 compares timestamps of multiple other consecutive images corresponding to a previous shooting request with timestamps of the multiple consecutive images corresponding to the shooting request. When a timestamp of one of the multiple consecutive images is the same as a timestamp of one of the multiple other consecutive images, the processor 150 deletes the one of the multiple consecutive images.

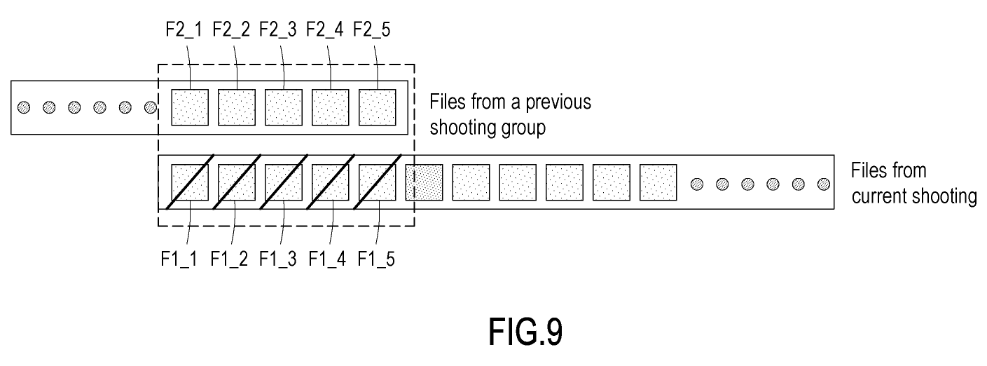

For example, referring to FIG. 9, which is a schematic diagram of deleting duplicate images according to an embodiment of the disclosure. The processor 150 compares the timestamps of multiple consecutive images F2_1 to FB_5 corresponding to a previous shooting request with the timestamps of multiple consecutive images FB_1 to F1_5 corresponding to the shooting request. Since the timestamps of the consecutive images F2_1 to FB_5 are respectively the same as the timestamps of the multiple consecutive images F1_1 to F1_5, the processor 150 deletes the consecutive images F1_1 to FB_B to avoid recording duplicate images.

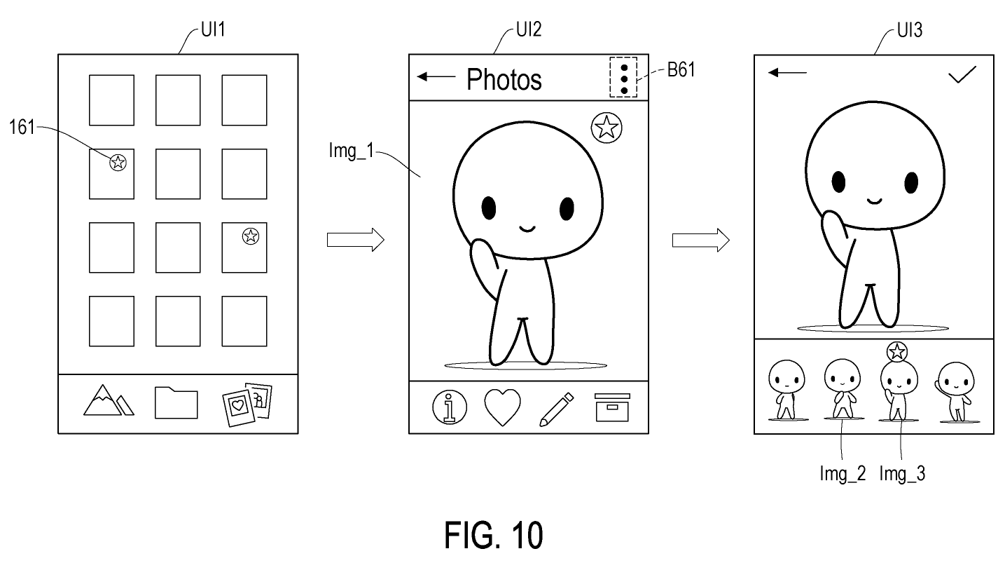

Please refer to FIG. 10, which is a schematic diagram of an operation interface according to an embodiment of the disclosure. When the user opens an album application (that is, the camera photo browser), the display 140 displays a user operation interface UI1. In the user operation interface UI1, one of the consecutive images from the same shooting request is displayed as a representative photo in the user operation interface UI1. A mark 161 be configured to indicate continuous shooting from the same shooting request. When the user clicks on a photo with the mark 161, the display 140 displays an editing interface UI2 for the consecutive images. In the editing interface UI2 for consecutive images, the user edits, sends, or views one (for example, a certain consecutive image Img_1) of the multiple consecutive images. When the user clicks on a control element B61, the display 140 displays a detailed display interface UI3 for the consecutive images. The user views each consecutive image (for example, consecutive images Img_2, Img_3) in the detailed display interface UI3 and change the settings for the representative photo.

In summary, in the embodiments of the disclosure, the continuous shooting mode is automatically enabled based on the object recognition result of the preview image. In addition, the source image stream for the continuous shooting mode is configured according to the remaining storage space. Based on the above, missing the best shooting opportunity due to the use of continuous shooting function is avoided, and the file size of consecutive images is reduced when the storage space is insufficient, thereby enhancing the practicality and timeliness of the continuous shooting function. Furthermore, since the source image stream for the continuous shooting mode is determined according to the ambient light information, smooth consecutive images is generated. Moreover, since duplicate images in different continuous shooting groups is deleted according to the timestamps of the consecutive images, the effect of saving storage space may be achieved.

Although the disclosure has been described with embodiments as above, the embodiments are not intended to limit the disclosure. Persons skilled in the art may make some changes and modifications without departing from the spirit and scope of the disclosure. Therefore, the protection scope of the disclosure should be defined by the appended claims.

What is claimed is:

1. A continuous shooting method, for an electronic device with an image sensor, wherein the method comprises:
using the image sensor to acquire a preview image;
determining whether to enable a continuous shooting mode based on an object recognition result of the preview image;
configuring a source image stream for the continuous shooting mode according to a remaining storage space upon enabling the continuous shooting mode, wherein the source image stream is generated from a plurality of raw images captured by the image sensor;
acquiring a plurality of consecutive images by using the source image stream upon receiving a shooting request; and
storing the consecutive images corresponding to the shooting request.

2. The continuous shooting method as claimed in claim 1, wherein determining whether to enable the continuous shooting mode based on the object recognition result of the preview image comprises:
performing an object recognition operation on the preview image to determine whether the preview image comprises a target object;
enabling the continuous shooting mode in response to the preview image comprising the target object; and
not enabling the continuous shooting mode in response to the preview image not comprising the target object.

3. The continuous shooting method as claimed in claim 1, wherein configuring the source image stream for the continuous shooting mode according to the remaining storage space upon enabling the continuous shooting mode comprises:
configuring the source image stream for the continuous shooting mode by a camera application according to the remaining storage space upon enabling the continuous shooting mode.

4. The continuous shooting method as claimed in claim 1, wherein configuring the source image stream for the continuous shooting mode according to the remaining storage space upon enabling the continuous shooting mode comprises:
determining the source image stream for the continuous shooting mode to be a preview image stream in response to the remaining storage space being below a threshold value.

5. The continuous shooting method as claimed in claim 4, wherein acquiring the plurality of consecutive images by using the source image stream upon receiving the shooting request comprises:
acquiring the consecutive images from the preview image stream according to a request time point of the shooting request upon receiving the shooting request and the source image stream being the preview image stream,
wherein the consecutive images comprise a main image corresponding to the request time point, a plurality of previous consecutive images before the main image, and a plurality of subsequent consecutive images after the main image.

6. The continuous shooting method as claimed in claim 4, wherein configuring the source image stream for the continuous shooting mode according to the remaining storage space upon enabling the continuous shooting mode further comprises:
determining the source image stream for the continuous shooting mode to be the preview image stream or a formal shooting image stream according to ambient light information in response to the remaining storage space not being below the threshold value.

7. The continuous shooting method as claimed in claim 6, wherein a resolution of the preview image stream is smaller than a resolution of the formal shooting image stream.

8. The continuous shooting method as claimed in claim 6, wherein determining the source image stream for the continuous shooting mode to be the preview image stream or the formal shooting image stream according to the ambient light information in response to the remaining storage space not being below the threshold value comprises:
determining whether the ambient light information meets a low lighting condition in response to the remaining storage space not being below the threshold value;
determining the source image stream for the continuous shooting mode to be the preview image stream in response to the remaining storage space not being below the threshold value and the ambient light information meeting the low lighting condition; and
determining the source image stream for the continuous shooting mode to be the formal shooting image stream in response to the remaining storage space not being below the threshold value and the ambient light information not meeting the low lighting condition.

9. The continuous shooting method as claimed in claim 6, wherein acquiring the plurality of consecutive images by using the source image stream upon receiving the shooting request comprises:
acquiring a plurality of previous consecutive images of the consecutive images from the formal shooting image stream upon receiving the shooting request and the source image stream being the formal shooting image stream, wherein the previous consecutive images are captured before a request time point of the shooting request.

10. The continuous shooting method as claimed in claim 1, wherein storing the consecutive images corresponding to the shooting request comprises:
comparing time stamps of a plurality of other consecutive images corresponding to a previous shooting request with time stamps of the consecutive images corresponding to the shooting request; and
deleting one of the consecutive images corresponding to the shooting request in response to a time stamp of the one of the consecutive images is the same as a time stamp of one of the other consecutive images.

11. An electronic device, comprising:
an image sensor; and
a processor coupled to the image sensor, and configured to:
use the image sensor to acquire a preview image;
determine whether to enable a continuous shooting mode based on an object recognition result of the preview image;
configure a source image stream for the continuous shooting mode according to a remaining storage space upon enabling the continuous shooting mode, wherein the source image stream is generated from a plurality of raw images captured by the image sensor;
acquire a plurality of consecutive images by using the source image stream upon receiving a shooting request; and
store the consecutive images corresponding to the shooting request.
